(19) United States
(12) Patent Application Publication
(10) Pub. No.: US 2023/0369637 A1
(43) Pub. Date: Nov. 16, 2023

(54) SECONDARY BATTERY

(71) Applicant: Envision AESC Energy Devices Ltd., Kanagawa (JP)

(72) Inventors: Koichi ZAMA, Sagamihara-shi (JP); Yasuhiro MATSUMARU, Sagamihara-shi (JP); Ryota YANAGISAWA, Sagamihara-shi (JP)

(73) Assignee: Envision AESC Energy Devices Ltd., Kanagawa (JP)

(21) Appl. No.: 18/358,305

(22) Filed: Jul. 25, 2023

Related U.S. Application Data
(62) Division of application No. 16/787,490, filed on Feb. 11, 2020.

(30) Foreign Application Priority Data
Sep. 29, 2017 (JP) 2017-190513

(51) Int. Cl. H01M 10/04; H01M 10/0525; H01M 10/0585; H01M 50/451; H01M 50/46; H01M 4/02

(52) U.S. Cl. CPC H01M 10/0431; H01M 10/0525; H01M 10/0585; H01M 50/451; H01M 50/461; H01M 2004/027; H01M 2004/028

(57) ABSTRACT

There is provided a secondary battery where the occurrence of adverse effects due to folds of a continuously folded separator is reduced. A secondary battery includes a plurality of sheet-like positive electrodes, a plurality of sheet-like negative electrodes, and a belt-like separator placed between the positive electrodes and the negative electrodes. The positive electrodes and the negative electrodes are alternately stacked with the separator interposed therebetween. The separator is continuously folded to be interposed between the positive electrodes and the negative electrodes. Folds of the continuously folded separator are at least a specified distance away from ends of the negative electrodes.

### TECHNICAL FIELD

The present invention relates to a secondary battery and, particularly, relates to a secondary battery where positive electrodes and negative electrodes are alternately stacked with a separator interposed therebetween.

### BACKGROUND ART

There is an increasing need for secondary batteries such as lithium-ion secondary batteries today. A stacked secondary battery is known as one type of secondary battery. In this stacked secondary battery, positive electrodes and negative electrodes are alternately stacked with a separator interposed therebetween.

For example, Patent Literatures 1 to 4 disclose a structure where a belt-like separator is continuously folded and placed between positive electrodes and negative electrodes. In the structures disclosed in Patent Literatures 1 to 4, the separator is folded at the ends of electrodes.

### CITATION LIST

### Patent Literature

PTL1: Japanese Unexamined Patent Application Publication No. 2002-329530
PTL2: Japanese Unexamined Patent Application Publication No. 2007-305464
PTL3: Japanese Unexamined Patent Application Publication No. 2010-199281
PTL4: Japanese Unexamined Patent Application Publication No. 2014-67619

### SUMMARY OF INVENTION

### Technical Problem

A separator can be shrunk by heat. Further, when a separator is continuously folded, a restoring force acts at a folded part. The inventor has found that, due to such causes, the following adverse effects occur when a folded position of a separator is at the ends of electrodes. Specifically, due to the shrinkage of the separator, the electrodes are pressed at folds of the separator to cause deformation of the electrodes, and due to the restoring force at folds, the stack swells out in the stacking direction.

Because the separator is folded at the ends of electrodes in the structures disclosed in Patent Literatures 1 to 4, there is a problem that the above-described adverse effects occur due to folds.

The present invention has been accomplished to solve the above problem, and an object of the present invention is thus to provide a secondary battery where the occurrence of adverse effects due to folds of a continuously folded separator is reduced.

### Solution to Problem

A secondary battery according to the present invention includes a plurality of sheet-like positive electrodes, a plurality of sheet-like negative electrodes, and a separator placed between the positive electrodes and the negative electrodes, wherein the positive electrodes and the negative electrodes are alternately stacked with the separator interposed therebetween, the separator is a belt-like separator and continuously folded to be interposed between the positive electrodes and the negative electrodes, and folds of the continuously folded separator are at least a specified distance away from ends of the negative electrodes.

### Advantageous Effects of Invention

According to the present invention, it is possible to provide a secondary battery where the occurrence of adverse effects due to folds of a continuously folded separator is reduced.

### BRIEF DESCRIPTION OF DRAWINGS

FIG. 1 is a view showing the overview of a secondary battery according to an embodiment;

FIG. 2 is a plan view from above showing the principal surface of the secondary battery according to the embodiment;

FIG. 3 is a cross-sectional view of the secondary battery according to the embodiment;

FIG. 4 is a plan view from above showing the top surface of a stack of the secondary battery according to the embodiment;

FIG. 5 is a cross-sectional view of a secondary battery according to an application example 1 of the embodiment;

FIG. 6 is a cross-sectional view of a secondary battery according to an application example 2 of the embodiment;

FIG. 7 is a plan view from above showing the top surface of a stack according to the application example 2 of the embodiment;

FIG. 8 is a plan view from above showing the top surface of a stack according to an application example 3 of the embodiment;

FIG. 9 is a cross-sectional view of a secondary battery according to the application example 3 of the embodiment;

FIG. 10 is a cross-sectional view of the secondary battery according to the application example 3 of the embodiment;

FIG. 11 is a plan view from above showing the top surface of a stack according to an application example 4 of the embodiment;

FIG. 12 is a cross-sectional view of a secondary battery according to the application example 4 of the embodiment;

FIG. 13 is a cross-sectional view of the secondary battery according to the application example 4 of the embodiment;

FIG. 14 is a plan view from above showing the top surface of a stack according to an application example 5 of the embodiment;

FIG. 15 is a cross-sectional view of a secondary battery according to the application example 5 of the embodiment;

FIG. 16 is a plan view from above showing the top surface of a stack according to the application example 5 of the embodiment;

FIG. 17 is a plan view from above showing the top surface of a stack according to an application example 6 of the embodiment; and

FIG. 18 is a cross-sectional view of a secondary battery according to the application example 6 of the embodiment.

### DESCRIPTION OF EMBODIMENTS

### Overview of Embodiment

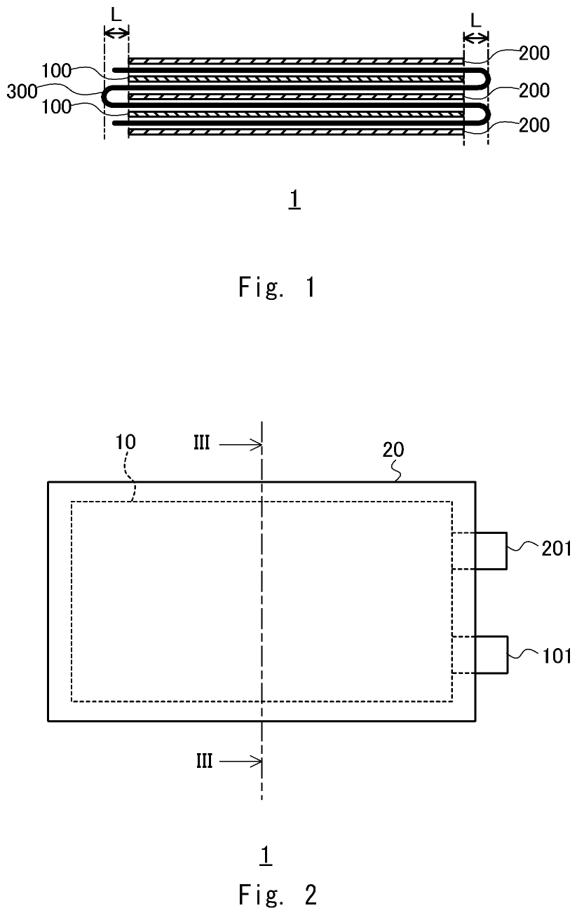

Prior to describing an embodiment, the overview of the embodiment according to the present invention is described hereinafter. FIG. 1 is a view showing the overview of a secondary battery 1 according to the embodiment of the present invention. The secondary battery 1 includes a plurality of sheet-like positive electrodes 100, a plurality of sheet-like negative electrodes 200, and a belt-like separator 300 placed between the positive electrodes 100 and the negative electrodes 200. Note that FIG. 1 shows a cross section of the positive electrodes 100, the negative electrodes 200 and the separator 300 stacked together.

As shown in FIG. 1, the positive electrodes 100 and the negative electrodes 200 are alternately stacked with the separator 300 interposed therebetween. The separator 300 is continuously folded in such a way that it is interposed between the positive electrodes 100 and the negative electrodes 200. The folds of the continuously folded separator 300 are placed in such a position that the distance from the folds to the ends of the positive electrodes 100 and the distance from the folds to the ends of the negative electrodes 200 are at least a specified length L.

Note that, although the positive electrodes 100 and the negative electrodes 200 have the same width in the example shown in FIG. 1, the width of the negative electrodes 200 is generally larger than the width of the positive electrodes 100. In this case, the distance from the ends of the electrodes with a larger width (the negative electrodes 200) to the folds of the separator 300 is L, and the distance from the ends of the electrodes with a smaller width (the positive electrodes 100) to the folds of the separator 300 is L′ (where L′>L). Further, although the two positive electrodes 100 and the three negative electrodes 200 are stacked in the example shown in FIG. 1, the numbers of the positive electrodes 100 and the negative electrodes 200 are not limited to this example.

The separator 300 is heated by heat caused by the temperature of the usage environment, heat generated during discharging and charging and the like. Thus, the separator 300 can be shrunk by heat. Therefore, when the folds of the separator 300 are at the ends of the electrodes, which is, when the folds are made to coincide with the width of the electrodes, the folds of the separator 300 press the electrodes due to the shrinkage of the separator 300, which deforms the electrodes. On the other hand, in the secondary battery 1, the folds are at least at a distance L away from the electrodes. Because of this allowance of the distance L, it is possible to prevent the electrodes from being pressed by the folds of the separator 300 even when the separator 300 is shrunk.

Further, because the belt-like separator 300 is folded at folds, the restoring force occurs at the folds. Specifically, a force acting to expand the folded separator 300 outward in the stacking direction (the vertical direction in FIG. 1) is exerted on the separator 300. Thus, when the folds of the separator 300 are at the ends of the electrodes, a stack composed of the positive electrodes 100, the negative electrodes 200 and the separator 300 swells out in the stacking direction by the restoring force at the folds. On the other hand, in the secondary battery 1, the folds are at least a distance L away from the electrodes. The restoring force acting on the positive electrodes 100 and the negative electrodes 200 is thereby reduced, which suppresses the swelling of the stack in the stacking direction.

Therefore, as described above, the occurrence of adverse effects due to the folds of the continuously folded separator 300 is reduced in the secondary battery 1.

### Details of Embodiment

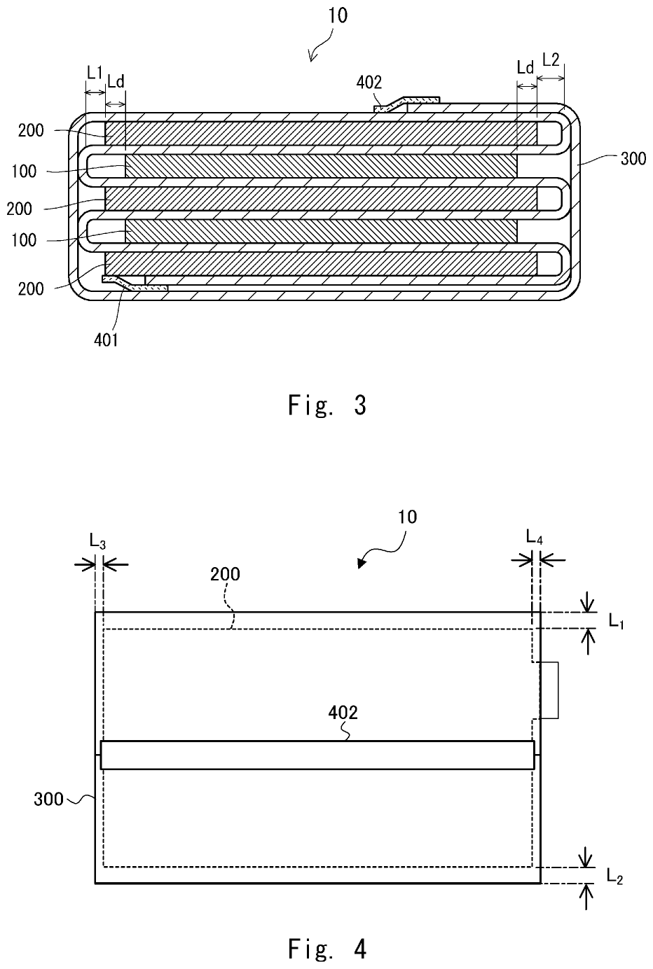

An embodiment of the present invention is described hereinafter with reference to the drawings. FIGS. 2 and 3 are schematic views showing the structure of the secondary battery 1 according to the embodiment. FIG. 2 is a plan view from above showing the principal surface (flat surface) of the secondary battery 1. FIG. 3 is a cross-sectional view along line III-III in FIG. 2. Note that FIG. 3 shows the cross section of a stack 10 of the secondary battery 1, and the illustration of a cover 20 is omitted. Further, although the two positive electrodes 100 and the three negative electrodes 200 are stacked in the example shown in FIG. 3, the numbers of the positive electrodes 100 and the negative electrodes 200 are not limited to this example.

In this embodiment, the secondary battery 1 is a stacked lithium-ion secondary battery. The secondary battery 1 includes the stack 10 where the positive electrodes 100 and the negative electrodes 200 are alternately stacked with the separator 300 interposed therebetween, and the cover 20. The stack 10 is contained together with an electrolytic solution (not shown) in the cover 20. The shape of the stack 10 and the cover 20 when viewed from above is substantially rectangular with long sides and short sides as shown in FIG. 2 in this embodiment.

Further, one end of a positive terminal 101 is connected to the group of positive electrodes 100, and one end of a negative terminal 201 is connected to the group of negative electrodes 200. The other end of the positive terminal 101 and the other end of the negative terminal 201 are led to the outside of the cover 20 as shown in FIG. 2. To be specific, the positive terminal 101 and the negative terminal 201 project to the outside from the same short side of the cover 20. For the positive terminal 101, aluminum, aluminum alloy or the like may be used, for example. For the negative terminal 201, copper, copper alloy, or nickel-plated copper or copper alloy may be used, for example.

The cover 20 contains the stack 10, which is the positive electrodes 100, the negative electrodes 200 and the separator 300 stacked together. Although the cover 20 is a laminate sheet, for example, it may be a can case. In the cover 20, a resin layer is formed on the front and back surfaces of a metal layer serving as a base material. A metal foil such as aluminum, for example, is used as the metal layer. A resin layer such as polypropylene, for example, is formed on the inner surface of the cover 20, which is the surface facing the stack 10. The resin layer on the inner surface of the cover 20 electrically isolates the metal layer of the cover 20 from the electrodes of the stack 10. Further, a resin layer such as nylon, for example, is formed on the outer surface of the cover 20. Note that the above-described materials of the metal layer and the resin layer of the cover 20 are merely examples, and other materials may be used.

The stack 10 is described hereinafter in detail with reference to FIG. 3. Since FIG. 3 shows the stack 10 only in a schematic manner, the thicknesses (i.e., the lengths in the stacking direction (the vertical direction in FIG. 3)) of the positive electrodes 100, the negative electrodes 200 and the separator 300 shown in FIG. 3 do not indicate the actual relationship of those thicknesses.

As described above, the stack 10 is contained together with an electrolytic solution in the cover 20. In the embodiment, this electrolytic solution is non-aqueous electrolyte. As the electrolytic solution, one type or a mixture of two more types of organic solvents like cyclic carbonates such as ethylene carbonate, propylene carbonate, vinylene carbonate and butylene carbonate, chain carbonates such as ethyl methyl carbonate (EMC), diethyl carbonate (DEC), dimethyl carbonate (DMC) and dipropyl carbonate (DPC), aliphatic carboxylic esters, γ-lactones such as γ-butyrolactone, chain ethers, and cyclic ethers may be used. Further, lithium salt may be dissolved into those organic solvents.

The stack 10 includes the positive electrodes 100, the negative electrodes 200 and one belt-like separator 300. Each of the positive electrodes 100 and the negative electrodes 200 has a substantially rectangular sheet shape, and they are alternately stacked with the separator 300 interposed therebetween.

Each of the plurality of sheet-like positive electrodes 100 is composed of a collector for positive electrode (positive collector) with a layer of an active material for positive electrode (positive active material) formed on both surfaces. Further, each of the plurality of sheet-like negative electrodes 200 is composed of a collector for negative electrode (negative collector) with a layer of an active material for negative electrode (negative active material) formed on both surfaces. The positive electrodes 100 and the negative electrodes 200 include a lead projecting from the rectangular shape, and this lead is connected to the positive terminal 101 or the negative terminal 201. Note that an active material is not formed in this lead.

The positive collector may be aluminum, stainless steel, nickel, titanium, or an alloy of them, for example. The negative collector may be copper, stainless steel, nickel, titanium, or an alloy of them, for example.

The positive active material may be layered oxide materials such as LiCoO₂, LiNiO₂, LiNi₍₁₋ₓ₎CoO₂, LiNiₓ(CoAl)₍₁₋ₓ₎O₂, Li₂MO₃—LiMO₂ and LiNi_{1/3}Co_{1/3}Mn_{1/3}O₂, spinel materials such as LiMn₂O₄, LiMn_{1.5}Ni_{0.5}O₄ and LiMn₍₂₋ₓ₎MₓO₄, olivine materials such as LiMPO₄, olivine fluoride materials such as Li₂MPO₄F and Li₂MSiO₄F, vanadium oxide materials such as V₂O₅, for example, and one type or a mixture of two more types of those materials may be used.

The negative active material may be carbon materials such as graphite, amorphous carbon, diamond-like carbon, fullerene, carbon nanotube and carbon nanohorn, alloy materials such as lithium-metal material, silicon and tin, oxide materials such as Nb₂O₅ and TiO₂, or a compound of those materials, for example.

In the embodiment, the negative electrodes 200 have a larger surface than the positive electrodes 100 in order to reduce the precipitation of Li on the surface or end face of the negative electrodes 200 due to stack displacement. Specifically, the width of the negative electrodes 200 is larger than the width of the positive electrodes 100 by Ld at both ends as shown in FIG. 3.

The belt-like separator 300 is placed between the positive electrodes 100 and the negative electrodes 200. Thus, the positive electrodes 100 and the negative electrodes 200 are stacked with the separator 300 interposed therebetween. Note that, in some cases, one of the both ends of the long side of the belt-like separator 300 is referred to as a leading end and, in such cases, the other one of the both ends of the long side of the separator 300 is referred to as a terminal end. In other cases, one of the both ends of the long side of the belt-like separator 300 may be referred to as a terminal end and, in such cases, the other one of the both ends of the long side of the separator 300 may be referred to as a leading end.

The separator 300 is mainly made of resin porous film, woven fabric, nonwoven fabric or the like. Resin materials to be used for the separator 300 are polyolefin resin such as polypropylene and polyethylene, polyester resin such as polyethylene terephthalate, acrylic resin, styrene resin, nylon resin and the like, for example. Further, in the embodiment, a layer containing insulating ceramic such as TiO₂ and Al₂O₃ is formed on one surface of the separator 300. The separator 300 isolates the positive electrodes 100 from the negative electrodes 200 while maintaining ionic conductivity between the positive electrodes 100 and the negative electrodes 200. In the embodiment, because one surface of the separator 300 is covered with ceramic as described above, the ceramic layer prevents short-circuit between the positive electrodes 100 and the negative electrodes 200 even when the resin layer of the separator 300 is melted by abnormal heating or the like of the secondary battery 1.

As shown in FIG. 3, the separator 300 is continuously folded in such a way that it is interposed between the positive electrodes 100 and the negative electrodes 200. In other words, the separator 300 is folded in a zigzag shape to thread between the positive electrodes 100 and the negative electrodes 200. To be specific, in the embodiment, the leading end of the belt-like separator 300 is secured by an adhesive tape 401 to the lower surface of the electrode in the lowermost layer of the group of electrodes of the stack 10 (the negative electrode 200 in the lowermost layer in the example of FIG. 3). The separator 300 is then continuously folded sequentially from the lowermost layer to the upper layer. The upper surface and the lower surface of the electrode in each layer of the stack 10 are covered in this manner.

Further, the terminal end part of the separator 300 covers a first side surface of the stack 10, the lower surface of the stack 10, a second side surface of the stack 10, and the upper surface of the stack 10. The first side surface is the side surface on one fold side of the separator 300, and it is the left side surface in FIG. 3. To be more specific, the first side surface is the side surface with the folds for covering the upper surface and the lower surface of the electrodes in the even-numbered layers from the uppermost layer (the positive electrodes 100 which are the second and fourth electrodes from the top in the example of FIG. 3). Further, the second side surface is the side surface on the other fold side of the separator 300, and it is the right side surface in FIG. 3. To be more specific, the second side surface is the side surface with the folds for covering the upper surface and the lower surface of the electrodes in the odd-numbered layers from the uppermost layer (the negative electrodes 200 which are the first, third and fifth electrodes from the top in the example of FIG. 3). Specifically, as shown in FIG. 3, when the separator 300 is viewed from the leading end to the terminal end, the separator 300 is continuously folded to cover each of the electrodes, and then covers the stack 10 (the group of electrodes) sequentially from the first side surface of the stack 10 (the group of electrodes), through the lower surface of the stack 10 (the group of electrodes) and the second side surface of the stack 10 (the group of electrodes), to the upper surface of the stack 10 (the group of electrodes). Further, the terminal end of the separator 300 is secured by an adhesive tape 402 to the separator 300 on the upper surface of the stack 10. In this manner, in this embodiment, the separator 300 covers all around the group of electrodes, which is the positive electrodes 100 and the negative electrodes 200 stacked together, by wrapping the terminal end part of the belt of separator 300 around the group of electrodes.

At the leading end and the terminal end of the belt of separator 300, the surface not covered with ceramic (which is the surface with resin) faces the outside of the stack 10, and the surface covered with ceramic faces the inside of the stack 10. The surface covered with ceramic has less adhesive strength against the specified adhesive tapes 401 and 402 than the surface not covered with ceramic. In this embodiment, because the surface not covered with ceramic faces the outside of the stack 10, the end part of the separator 300 can be more reliably secured by the adhesive tapes 401 and 402 attached to the outside surface of the end part of the separator 300.

Although a tape of any material can be used for the adhesive tapes 401 and 402, it is preferred to use a material that is insulating and resistant to an electrolytic solution. For example, a resin tape such as polypropylene may be used as the adhesive tapes 401 and 402.

Further, the folds of the continuously folded separator 300 on the first side surface side are placed in such a position that the distance from the folds to the ends of the negative electrodes 200 is a specified length L1. In other words, the folds of the separator 300 on the first side surface side are at a distance of the specified length L1 from the ends of the negative electrodes 200. Accordingly, the folds of the continuously folded separator 300 on the first side surface side are placed in such a position that the distance from the folds to the ends of the positive electrodes 100 is L1+Ld.

Likewise, the folds of the continuously folded separator 300 on the second side surface side are placed in such a position that the distance from the folds to the ends of the negative electrodes 200 is a specified length L2. In other words, the folds of the separator 300 on the second side surface side are at a distance of the specified length L2 from the ends of the negative electrodes 200. Accordingly, the folds of the continuously folded separator 300 on the second side surface side are placed in such a position that the distance from the folds to the ends of the positive electrodes 100 is L2+Ld.

Note that the lengths L1 and L2 may be the same or different. In this manner, the folds of the continuously folded separator 300 are at least a distance of the specified length (L1 or L2) away from the ends of the electrodes.

FIG. 4 is a schematic plan view from above showing the top surface of the stack 10. In FIG. 4, the positive electrodes 100 are not shown to simplify the drawing. The belt-like separator 300 is continuously folded back and forth along the short side (the vertical direction in FIG. 4) of the positive electrodes 100 and the negative electrodes 200. The belt-like separator 300 has a rectangular shape, like the electrodes, when it is folded. Further, when folded, the separator 300 has a long side that is substantially the same length as the long side of the electrodes and a short side that is substantially the same length as the short side of the electrodes. To be more specific, however, the length of the short side of the separator 300 when folded is longer than the short side of the negative electrodes 200, which is the width of the negative electrodes 200, by a specified length (=L1+L2).

Further, in this embodiment, the length of the separator 300 in the crease direction of continuous folding (which is the horizontal direction in FIG. 4, along the long side of the separator 300 when folded) is longer than the length of the positive electrodes 100 and the negative electrodes 200 in this direction as shown in FIG. 4. Specifically, one end side of the separator 300 in the crease direction (the left end side of the separator 300 in FIG. 4) is longer than the negative electrodes 200 by a specified length L3. Further, the other end side of the separator 300 in the crease direction (the right end side of the separator 300 in FIG. 4) is longer than the negative electrodes 200 by a specified length L4. Note that the length of the positive electrodes 100 in this direction is shorter than the length of the negative electrodes 200 in this direction. The length L3 and the length L4 may be the same or different. Note that, although the length of the separator 300 in the crease direction of continuous folding is preferably longer than the negative electrodes 200, it may be the same length as the negative electrodes 200. Further, the separator 300 may be longer than the negative electrodes 200 only in one of the both ends in the crease direction.

The structure of the secondary battery 1 is described above. As described above, the folds of the continuously folded separator 300 are at a distance of a specified length (L1 or L2) from the ends of the negative electrodes 200. It is thereby possible to reduce the occurrence of adverse effects due to folds, such as the pressure on the electrodes by the shrinkage of the separator 300 and the restoring force acting on the group of electrodes. Particularly, in the embodiment, parts around the folds of the separator 300 are enclosed in the cover 20 without being bonded in the stacking direction. Specifically, parts of the separator 300 projecting from the negative electrodes 200 to the outside in the back-and-forth direction (i.e., in the continuous folding direction) of the separator 300 are enclosed in the cover 20 without being bonded in the stacking direction. Thus, reduction of the restoring force by bonding in the stacking direction cannot be achieved. On the other hand, in this embodiment, the folds and the ends of the electrodes are distant from each other to thereby reduce the effect of the restoring force.

Further, as described above, the separator 300 covers all around the group of stacked electrodes. The following effects are thereby obtained. As described earlier, the resin layer is formed on the cover 20, and the metal layer of the cover 20 and the electrodes of the stack 10 are electrically insulated from each other. However, in the case where metal powder is mixed in the process of manufacture of the secondary battery 1 or the like, for example, there is a possibility that this metal powder sticks into the resin layer of the cover 20, and the electrodes and the metal layer of the cover 20 are short-circuited through this metal powder. Further, in the process of manufacture of the positive electrodes 100 and the negative electrodes 200, a burr can occur while cutting a collector into predetermined shapes. There is a possibility that this burr sticks into the resin layer of the cover 20, causing short circuit between the electrodes and the metal layer of the cover 20. On the other hand, in this embodiment, the group of electrodes is covered with the separator 300. Specifically, the separator 300 is placed between the cover 20 and the group of electrodes. It is thereby possible to avoid short-circuit between the cover 20 and the electrodes due to metal powder and burrs.

Further, when the shape of the electrodes is a rectangle as in this embodiment, there is a possibility that a corner of the rectangle sticks into the resin layer of the cover 20, causing short-circuit between the electrodes and the metal layer of the cover 20. However, in this embodiment, the length of the separator 300 in the crease direction of continuous folding is longer than the length of the positive electrodes 100 and the negative electrodes 200 in the same direction. This prevents corners of the positive electrodes 100 and the negative electrodes 200 from sticking into the resin layer of the cover 20.

As the separator 300 is longer, the effect of shrinkage becomes more significant. To be specific, it is assumed that the length from one fold to the other fold of the separator 300 is X, and the separator with the length X is shrunk by a length Xd in a certain temperature environment. In this case, Xd increases as X increases. In the embodiment, the separator 300 is continuously folded back and forth along the short side of the group of electrodes as described above. Therefore, the effect of shrinkage is smaller than when the separator 300 is continuously folded back and forth along the long side of the group of electrodes. Thus, the distance (i.e., L1 or L2) between the folds and the electrode ends can be further shortened. It is thereby possible to reduce the entire length of the belt-like separator 300 and decrease the costs of the separator 300.

Further, as described above, the separator 300 has the first surface and the second surface, which is the back side of the first surface in this embodiment. The second surface is covered with ceramic, and therefore it has less adhesive strength against the specified adhesive tapes 401 and 402 than the first surface. At the leading end and the terminal end of the belt of separator 300, the first surface faces outward, and the second surface faces inward. This enables the end part of the separator 300 to be more securely secured by the adhesive tapes 401 and 402.

Application examples of the above-described embodiment are described hereinbelow. Note that, in the following description, the description of the same elements as those in the above-described embodiment is omitted, and differences from the above-described embodiment are mainly described as application examples.

### Application Example 1

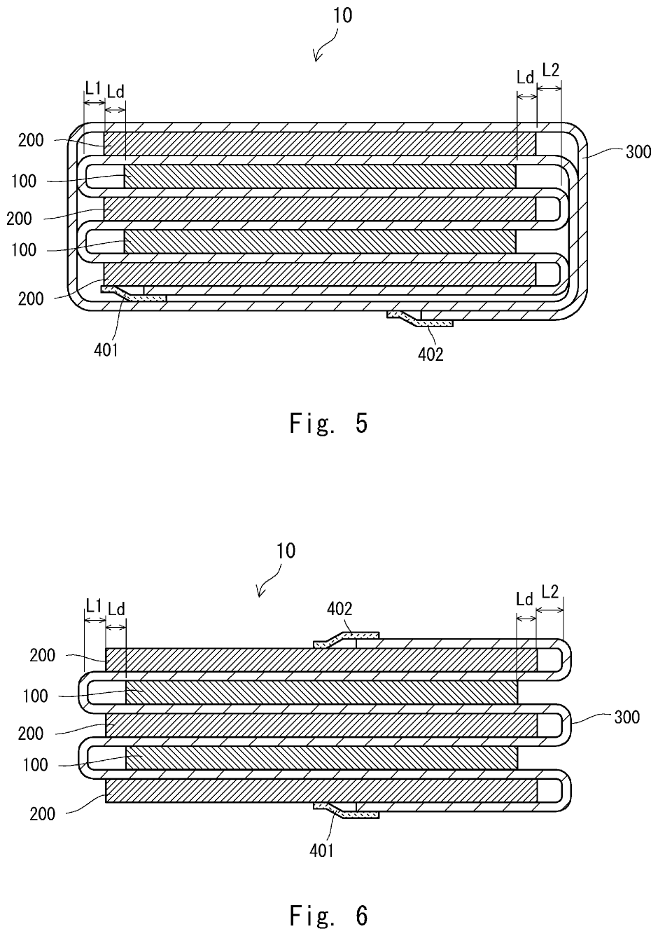

A way of wrapping the continuously folded separator 300 to cover all around the group of electrodes is arbitrary. FIG. 5 is a cross-sectional view of the secondary battery 1 according to an application example 1 of the embodiment. Note that FIG. 5 shows the cross section of the stack 10 of the secondary battery 1, and the illustration of the cover 20 is omitted just like in FIG. 3. Further, although the two positive electrodes 100 and the three negative electrodes 200 are stacked in the example shown in FIG. 5, the numbers of the positive electrodes 100 and the negative electrodes 200 are not limited to this example.

In the application example 1, the leading end of the belt-like separator 300 is secured by the adhesive tape 401 to the lower surface of the electrode in the lowermost layer of the group of electrodes of the stack 10 (the negative electrode 200 in the lowermost layer in the example of FIG. 5). The separator 300 is then continuously folded sequentially from the lowermost layer to the upper layer. In the example shown in FIG. 5, however, continuous folding for covering the electrode in the uppermost layer (the negative electrode 200 in the uppermost layer in the example of FIG. 5) is not done, which is different from the example shown in FIG. 3. Specifically, in the example shown in FIG. 5, the separator 300 covers, by being continuously folded, the electrodes sequentially from the electrode in the lowermost layer up to the electrode in the second layer from the top.

The terminal end part of the separator 300 covers a first side surface of the stack 10, the lower surface of the stack 10, a second side surface of the stack 10, and the upper surface of the stack 10. The first side surface as referred to herein is the side surface on one fold side of the separator 300, and it is the right side surface in FIG. 5. To be more specific, the first side surface as referred to herein is the side surface with the folds for covering the upper surface and the lower surface of the electrodes in the odd-numbered layers from the lowermost layer (the negative electrodes 200 which are the first and third electrodes from the bottom in the example of FIG. 5). Further, the second side surface as referred to herein is the side surface on the other fold side of the separator 300, and it is the left side surface in FIG. 5. To be more specific, the second side surface as referred to herein is the side surface with the folds for covering the upper surface and the lower surface of the electrodes in the even-numbered layers from the lowermost layer (the positive electrodes 100 which are the second and fourth electrodes from the bottom in the example of FIG. 5). Specifically, as shown in FIG. 5, when the separator 300 is viewed from the leading end to the terminal end, the separator 300 is continuously folded to cover each of the electrodes (excluding the upper surface of the electrode in the uppermost layer), and then covers the stack 10 (the group of electrodes) sequentially from the first side surface of the stack 10 (the group of electrodes), through the lower surface of the stack 10 (the group of electrodes), the second side surface of the stack 10 (the group of electrodes), the upper surface of the stack 10 (the group of electrodes), the first side surface of the stack 10 (the group of electrodes), to the lower surface of the stack 10 (the group of electrodes). Further, the terminal end of the separator 300 is secured by an adhesive tape 402 to the separator 300 on the lower surface of the stack 10. Although the terminal end of the separator 300 comes to the lower surface of the stack 10 in the example shown in FIG. 5, it may end at the first side surface of the stack 10.

In this manner, various ways of wrapping the separator 300 are possible to cover all around the group of electrodes.

### Application Example 2

Although the separator 300 covers all around the group of electrodes in the above-described embodiment and its application example, the separator 300 may cover only a part of the periphery of the group of electrodes. Although it is preferred to cover the entire periphery of the group of electrodes in order to avoid short-circuit between the cover 20 and the electrodes, the separator 300 does not necessarily cover the entire periphery of the group of electrodes in terms of easier manufacture.

FIG. 6 is a cross-sectional view of the secondary battery 1 according to an application example 2 of the embodiment. Note that FIG. 6 shows the cross section of the stack 10 of the secondary battery 1, and the illustration of the cover 20 is omitted just like in FIG. 3. Further, although the two positive electrodes 100 and the three negative electrodes 200 are stacked in the example shown in FIG. 6, the numbers of the positive electrodes 100 and the negative electrodes 200 are not limited to this example.

In the application example 2, the leading end of the belt-like separator 300 is secured by the adhesive tape 401 to the lower surface of the electrode in the lowermost layer of the group of electrodes of the stack 10 (the negative electrode 200 in the lowermost layer in the example of FIG. 6). Note that, in the example shown in FIG. 6, the leading end of the separator 300 is secured by the adhesive tape 401 to some midpoint of the width of the electrode in the lowermost layer. Thus, the leading end part of the belt of separator 300 covers a part of the lower surface of the electrode in the lowermost layer in the stacking direction among the positive electrodes 100 and the negative electrodes 200 stacked together.

The separator 300 is then continuously folded sequentially from the lowermost layer to the upper layer. In the application example 2, the terminal end part of the separator 300 is not wrapped around the stack 10, which is different from the above-described embodiment and its application example 1. Specifically, as shown in FIG. 6, the terminal end of the separator 300 is secured by the adhesive tape 402 to the upper surface of the electrode in the uppermost layer (the negative electrode 200 in the uppermost layer in the example of FIG. 6) in the application example 2. To be more specific, the terminal end of the separator 300 is secured to some midpoint of the width of the electrode in the uppermost layer. Thus, the terminal end part of the belt of separator 300 covers a part of the upper surface of the electrode in the uppermost layer in the stacking direction among the positive electrodes 100 and the negative electrodes 200 stacked together. Note that, in the application example 2 also, at the leading end and the terminal end of the belt of separator 300, the surface not covered with ceramic faces the outside of the stack 10, and the surface covered with ceramic faces the inside of the stack 10.

In this manner, a part of the upper surface of the electrode in the uppermost layer and a part of the lower surface of the electrode in the lowermost layer are covered with the separator 300 in the application example 2. On the surface covered with the separator 300, short-circuit with the metal layer of the cover 20 is avoided. Therefore, it is possible to reduce short-circuit between the cover 20 and the electrodes compared with the case where the whole of the upper surface of the electrode in the uppermost layer and the whole of the lower surface of the electrode in the lowermost layer are not covered with the separator 300.

Although a part of the upper surface of the electrode in the uppermost layer and a part of the lower surface of the electrode in the lowermost layer are covered with the separator 300 in the example shown in FIG. 6, a part of the upper surface of the electrode in the uppermost layer may be covered with the separator 300, and the lower surface of the electrode in the lowermost layer may be not covered with the separator 300. Likewise, the upper surface of the electrode in the uppermost layer may be not covered with the separator 300, and a part of the lower surface of the electrode in the lowermost layer may be covered with the separator 300. Further, the whole of the upper surface of the electrode in the uppermost layer may be covered, or the whole of the lower surface of the electrode in the lowermost layer may be covered.

### Application Example 3

The present inventors have found that, in some combination of materials of the electrodes, the electrolytic solution and the separator, damage can occur in the separator 300 that covers the upper surface of the electrode in the uppermost layer or the lower surface of the electrode in the lowermost layer. Damage that can occur in the separator 300 is described hereinafter with reference to the drawings.

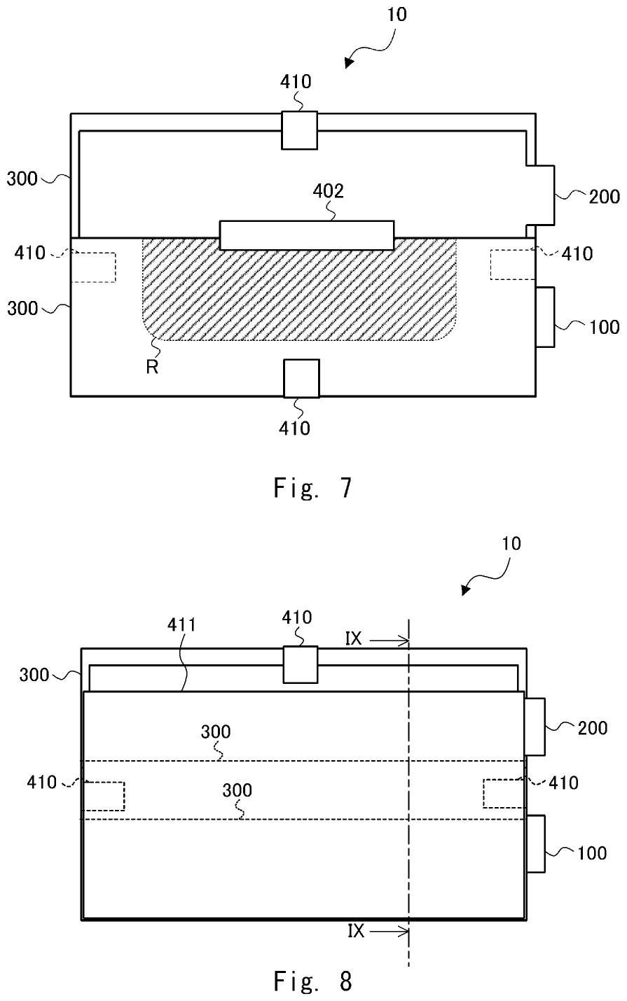

FIG. 7 is a schematic plan view from above showing the top surface of the stack 10 according to the application example 2 shown in FIG. 6. As described above, in the application example 2, the separator 300 covers a part of the negative electrode 200 in the uppermost layer, and it is secured by the adhesive tape 402. Note that adhesive tapes 410 on four sides shown in FIG. 7 are adhesive tapes that cover the stack 10 in the stacking direction in order to prevent the stack 10 from being separated. In FIG. 7, a region R of the separator 300 schematically shows the area in which the above-described damage can occur. Specifically, the inventors have found that damage can occur in the region of the separator 300 that covers the center part of the electrodes located in the outermost layers. Note that, although FIG. 7 shows the damaged area of the separator 300 located in the uppermost layer, damage can occur in the region of the separator 300 that covers the center part of the electrode also in the damaged area of the separator 300 located in the lowermost layer.

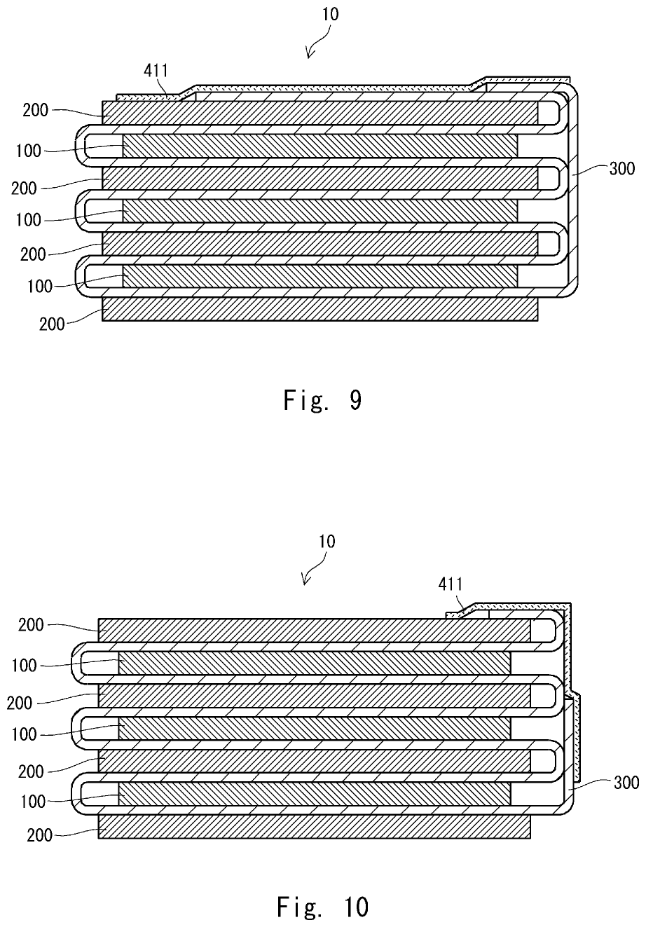

In order to prevent the occurrence of such damage, a structure in which the separator 300 is protected by an adhesive tape 411 is described in the application example 3. FIG. 8 is a schematic plan view from above showing the top surface of the stack 10 according to the application example 3 of the embodiment. FIG. 9 is a cross-sectional view of the secondary battery 1 according to the application example 3 of the embodiment. Specifically, FIG. 9 is a cross-sectional view along line IX-IX in FIG. 8. Note that, however, the illustration of the cover 20 is omitted in FIGS. 8 and 9. Further, although the three positive electrodes 100 and the four negative electrodes 200 are stacked in the example shown in FIG. 9, the numbers of the positive electrodes 100 and the negative electrodes 200 are not limited to this example.

As shown in FIGS. 8 and 9, the stack 10 according to the application example 3 includes the adhesive tape 411 that secures the end part (i.e., the leading end and the terminal end) of the belt of separator 300. The end part (i.e., the leading end and the terminal end) of the belt of separator 300 that covers the outer surface of the electrode located in the outermost layer in the stacking direction is entirely covered with the adhesive tape 411. The inventors have found that the occurrence of damage is suppressed when it is covered with the adhesive tape 411. This is considered to be because the separator 300 located in the outermost layer is protected by the adhesive tape 411.

Further, as shown in FIGS. 8 and 9, in the stack 10 according to the application example 3, the outer surface of one of the electrodes located in the outermost layers (to be specific, the negative electrode 200 in the lowermost layer) is not covered with the separator 300. Therefore, the above-described damage does not occur in the lowermost layer.

The stack 10 according to the application example 3 shown in FIGS. 8 and 9 has the following structure. In the application example 3, the leading end of the belt-like separator 300 is secured by the adhesive tape 411 to the upper surface of the electrode in the uppermost layer of the group of electrodes of the stack 10 (the negative electrode 200 in the uppermost layer in the example of FIG. 9). The separator 300 is then continuously folded sequentially from the uppermost layer to the lower layer. In the example shown in FIG. 7, however, continuous folding for covering the electrode in the lowermost layer (the negative electrode 200 in the lowermost layer in the example of FIG. 9) is not done. Specifically, in the example shown in FIG. 9, the separator 300 covers, by being continuously folded, the electrodes sequentially from the electrode in the uppermost layer down to the electrode in the second layer from the bottom.

The terminal end part of the separator 300 covers the side surface of the stack 10 and a part of the upper surface of the stack 10. The side surface as referred to herein is the side surface on one fold side of the separator 300, and it is the right side surface in FIG. 9. Specifically, as shown in FIG. 9, when the separator 300 is viewed from the leading end to the terminal end, the separator 300 is continuously folded to cover each of the electrodes (excluding the lower surface of the electrode in the lowermost layer), and then covers the stack (the group of electrodes) sequentially from the side surface of the stack 10 (the group of electrodes) to the upper surface of the stack 10 (the group of electrodes). Further, the terminal end of the separator 300 is secured to the separator 300 on the upper surface of the stack 10 by the same adhesive tape 411 as the tape that secures the leading end of the separator 300. Note that, although the terminal end of the separator 300 comes to the upper surface of the stack 10 in the example shown in FIG. 9, it may end at the side surface of the stack 10 as shown in FIG. 10. In the structure shown in FIG. 10, the adhesive tape 411 secures both of the leading end of the separator 300 that covers the outer surface of the electrode in the outermost layer and the terminal end of the separator 300 that covers the side surface.

Further, although the outer surface of one (to be specific, the negative electrode 200 in the lowermost layer) of the two electrodes located in the outermost layers is not covered with the separator 300 in the structure shown in FIGS. 9 and 10, this outer surface may be covered with the separator 300.

### Application Example 4

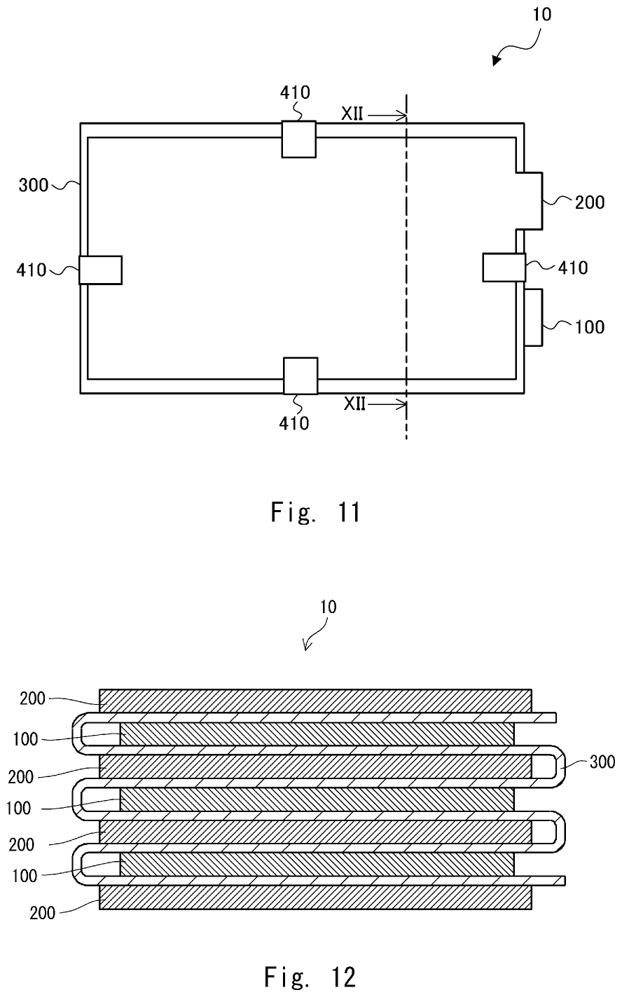

In order to prevent damage in the separator 300, the stack 10 may have a structure in which both of the upper surface of the electrode in the uppermost layer and the lower surface of the electrode in the lowermost layer are not covered with the separator 300. FIG. 11 is a schematic view from above showing the top surface of the stack 10 according to an application example 4 of the embodiment. FIG. 12 is a cross-sectional view of the secondary battery 1 according to the application example 4 of the embodiment. Specifically, FIG. 12 is a cross-sectional view along line XII-XII in FIG. 11. Note that, however, the illustration of the cover 20 is omitted in FIGS. 11 and 12. Further, although the three positive electrodes 100 and the four negative electrodes 200 are stacked in the example shown in FIG. 12, the numbers of the positive electrodes 100 and the negative electrodes 200 are not limited to this example.

As shown in FIGS. 11 and 12, in the application example 4, the outer surfaces of the electrodes in the outermost layers (to be specific, the upper surface of the negative electrode 200 in the uppermost layer and the lower surface of the negative electrode 200 in the lowermost layer) are not covered with the separator 300. Therefore, the above-described damage of the separator 300 does not occur.

Specifically, the stack 10 according to the application example 4 shown in FIGS. 11 and 12 has the following structure. In the application example 4, the separator 300 covers, by being continuously folded, from the upper surface of the electrode located in the second layer from the uppermost layer of the group of electrodes of the stack 10 (the positive electrode 100 which is the second electrode from the top in the example of FIG. 12) to the lower surface of the electrode located in the second layer from the lowermost layer of the group of electrodes of the stack 10 (the positive electrode 100 which is the second electrode from the bottom in the example of FIG. 12). Further, the stack 10 is secured on four sides by the adhesive tapes 410 that cover the stack 10 in the stacking direction in order to prevent the stack 10 from being separated.

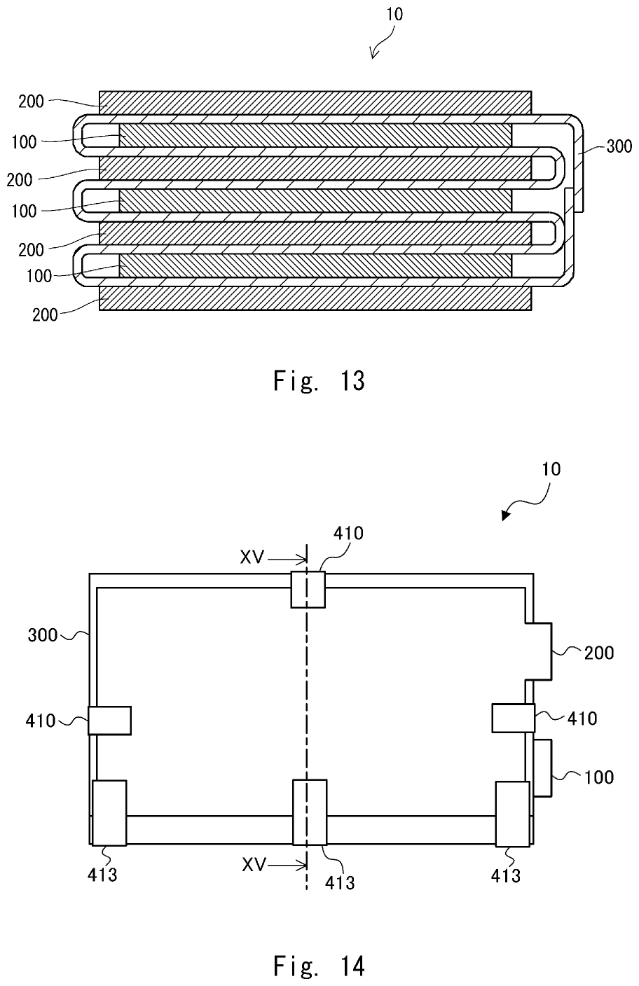

Note that both end parts of the separator 300 are located in line with the folds of the separator 300 in the example shown in FIG. 12, they may extend to the side surface of the stack 10 as shown in FIG. 13. Specifically, the end parts of the separator 300 may cover the side surface of the stack 10. The side surface as referred to herein is the side surface on one fold side of the separator 300, and it is the right side surface in FIG. 13.

### Application Example 5

The above-described application example 4 describes the structure example in which the separator 300 does not cover the whole of the upper surface of the electrode in the uppermost layer in the stacking direction and the whole of the lower surface of the electrode in the lowermost layer in the stacking direction. However, as described above, damage of the separator 300 occurs in the center part of the electrode. Therefore, the separator 300 may cover the area other than the center part of the outer surfaces of the electrodes in the outermost layers. Specifically, the stack 10 may have a structure in which the separator 300 does not cover the center part of the upper surface of the electrode located in the uppermost layer in the stacking direction or the center part of the lower surface of the electrode located in the lowermost layer in the stacking direction among the positive electrodes 100 and the negative electrodes 200 stacked together. An application example 5 describes a structure example of the stack 10 in which the area other than the center part of the electrodes in the outermost layers is covered.

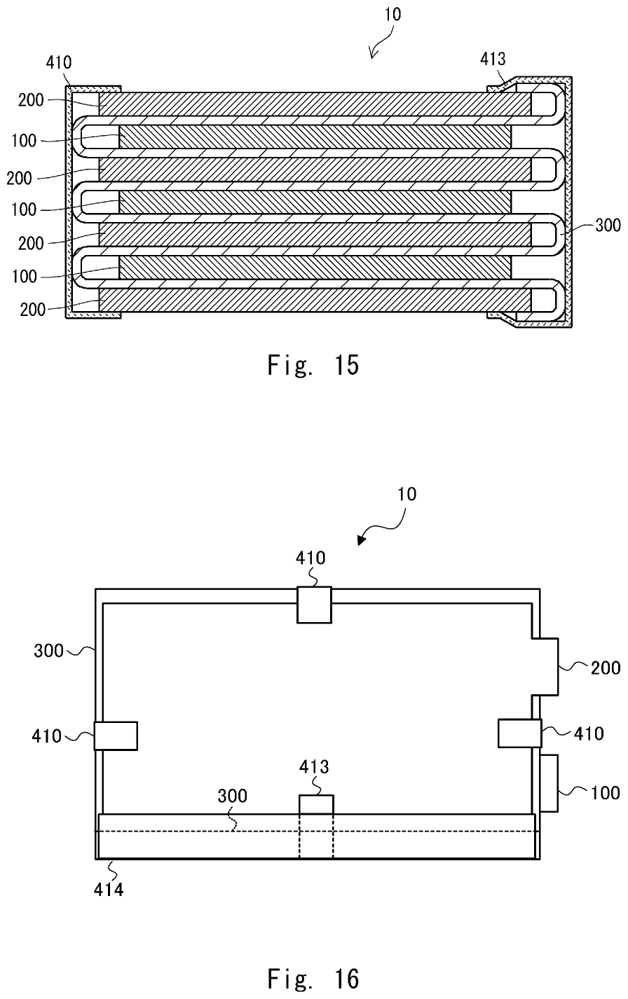

FIG. 14 is a schematic plan view from above showing the top surface of the stack 10 according to the application example 5 of the embodiment. FIG. 15 is a cross-sectional view of the secondary battery 1 according to the application example 5 of the embodiment. Specifically, FIG. 15 is a cross-sectional view along line XV-XV in FIG. 14. Note that, however, the illustration of the cover 20 is omitted in FIGS. 14 and 15. Further, although the three positive electrodes 100 and the four negative electrodes 200 are stacked in the example shown in FIG. 15, the numbers of the positive electrodes 100 and the negative electrodes 200 are not limited to this example.

As shown in FIG. 15, the application example 5 is different from the structure shown in FIG. 12 in that the both ends of the separator 300 are folded onto the outer surfaces of the electrodes in the outermost layers. The separator 300 folded onto the outer surfaces of the electrodes in the outermost layers cover a part of the outer surfaces of the electrodes in the outermost layers. Thus, the separator 300 covers only the rim of the electrode, and does not cover the center part of the electrode.

The ends of the separator 300 folded onto the outer surfaces of the electrodes in the outermost layers are secured to the outer surfaces of the electrodes in the outermost layers by an adhesive tape 413 that covers the stack 10 in the stacking direction. Therefore, as shown in FIG. 14, the stack 10 is secured by the adhesive tapes 410 on three sides excluding the side surface where the separator 300 is folded onto the outer surfaces of the electrodes in the outermost layers, and this side surface is secured by the adhesive tape 413.

Note that, although the folded end of the separator 300 is secured to the outer surfaces of the electrodes by the three adhesive tapes 413 that cover the stack 10 in the stacking direction in the structure shown in FIG. 14, the folded end of the separator 300 may be secured to the outer surfaces of the electrodes as shown in FIG. 16. The structure shown in FIG. 16 includes an adhesive tape 414 that secures the end of the separator 300 entirely to the outer surfaces of the electrodes. In the structure shown in FIG. 16, the end part of the belt of separator 300 that covers the outer surface of the electrode located in the outermost layer in the stacking direction is entirely covered with the adhesive tape 414, just like in the application example 3. Therefore, the separator 300 located in the outermost layer is protected by the adhesive tape 414.

### Application Example 6

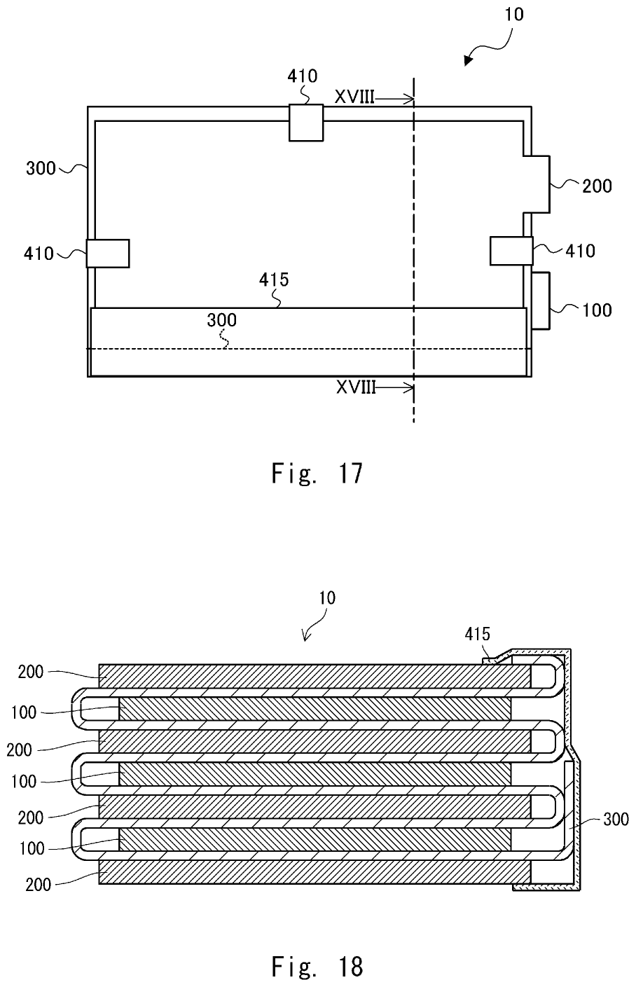

Although the structure in which the both ends of the separator 300 are folded onto the outer surfaces of the electrodes in the outermost layers is described in the application example 5, only one end of the separator 300 may be folded onto the outer surfaces of the electrodes in the outermost layers. FIG. 17 is a schematic plan view from above showing the top surface of the stack 10 according to the application example 6 of the embodiment. FIG. 18 is a cross-sectional view of the secondary battery 1 according to the application example 6 of the embodiment. Specifically, FIG. 18 is a cross-sectional view along line XVIII-XVIII in FIG. 17. Note that, however, the illustration of the cover 20 is omitted in FIGS. 17 and 18. Further, although the three positive electrodes 100 and the four negative electrodes 200 are stacked in the example shown in FIG. 18, the numbers of the positive electrodes 100 and the negative electrodes 200 are not limited to this example.

As shown in FIG. 18, in the stack 10 according to the application example 6, one end of the separator 300 is folded onto the outer surfaces of the electrodes in the outermost layers. Specifically, one end of the separator 300 covers a part of the outer surface of the electrode in the uppermost layer. The other end of the separator 300 extends to the side surface of the stack 10. Thus, the other end of the separator 300 covers a part of the side surface of the stack 10. The side surface as referred to herein is the side surface on one fold side of the separator 300, and it is the right side surface in FIG. 18. Further, an adhesive tape 415 secures both of the leading end of the separator 300 that covers the outer surface of the electrode in the uppermost layer and the terminal end of the separator 300 that covers the side surface. Note that the adhesive tape 415 entirely covers the end part of the belt of separator 300 that covers the outer surface of one electrode located in the outermost layer in the stacking direction. Thus, the separator 300 located in the outermost layer is protected by the adhesive tape 411. Further, as shown in FIG. 18, in the stack 10 according to the application example 6, the outer surface of the other electrode located in the outermost layer (the negative electrode 200 in the lowermost layer in FIG. 18) is not covered with the separator 300. Therefore, the above-described damage does not occur in the lowermost layer.

In the application examples 3 to 6, the structure in which the separator in the outermost layer is entirely covered with the adhesive tape, the structure in which the outer surface of the electrode in the outermost layer is not covered with the separator, and the structure in which the area other than the center part of the electrode in the outermost layer is covered with the separator are described as the structure for suppressing damage in the separator. The same structure among those structures may be used for both of the uppermost layer and the lowermost layer of the stack, or different structures may be used as shown in FIGS. 9 and 10. Further, any one of those structures may be combined with the structure of the embodiment or the application example 1 or 2.

It should be noted that the present invention is not limited to the above-described example embodiments and may be varied in many ways within the scope of the present invention. For example, although the secondary battery 1 is a lithium-ion secondary battery in the above-described example, the present invention may be applied to another type of secondary battery. Further, although the electrode located in the outermost layer in the stacking direction is the negative electrode 200 in the above-described embodiment and its application examples, the positive electrode 100 may be the electrode located in the outermost layer.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-190513 filed on Sep. 29, 2017, the disclosure of which is incorporated herein in its entirety by reference.

### REFERENCE SIGNS LIST

1 SECONDARY BATTERY
10 STACK
20 COVER
100 POSITIVE ELECTRODE
101 POSITIVE TERMINAL
200 NEGATIVE ELECTRODE
201 NEGATIVE TERMINAL
300 SEPARATOR
401, 402, 410, 411, 413, 414, 415 ADHESIVE TAPE

1. A secondary battery comprising:
a plurality of sheet-like positive electrodes;
a plurality of sheet-like negative electrodes; and
a belt-like separator placed between the plurality of sheet-like positive electrodes and the plurality of sheet-like negative electrodes; and
an adhesive tape, wherein
the plurality of sheet-like positive electrodes and the plurality of sheet-like negative electrodes are alternately stacked with the separator interposed therebetween,
the belt-like separator is continuously folded in a zigzag shape to be interposed between the plurality of sheet-like positive electrodes and the plurality of sheet-like negative electrodes, and
folds of the continuously folded belt-like separator are away from ends of the plurality of sheet-like negative electrodes by a distance for preventing the plurality of sheet-like positive electrodes and the plurality of sheet-like negative electrodes from being pressed by the folds of the belt-like separator, and
the belt-like separator is secured by the adhesive tape to an electrode in at least one outermost layer of a group of electrodes being the plurality of sheet-like positive electrodes and the plurality of sheet-like negative electrodes stacked together on an outer surface of the outermost electrode, and
the belt-like separator located in an outermost layer in a stacking direction is entirely covered with the adhesive tape.

2. The secondary battery according to claim 1, further comprising:
a cover configured to contain the plurality of sheet-like positive electrodes, the plurality of sheet-like negative electrodes and the belt-like separator stacked together,
wherein the belt-like separator covers at least part of an upper surface of an electrode located in an uppermost layer in a stacking direction or at least part of a lower surface of an electrode located in a lowermost layer in the stacking direction, among the plurality of sheet-like positive electrodes and the plurality of sheet-like negative electrodes stacked together, with a leading end part or a terminal end part of the belt-like separator.

3. The secondary battery according to claim 2, wherein the belt-like separator covers all around a group of electrodes being the plurality of sheet-like positive electrodes and the plurality of sheet-like negative electrodes stacked together by wrapping a leading end part or a terminal end part of the belt-like separator around the group of electrodes.

4. The secondary battery according to claim 1, wherein a length of the belt-like separator in a crease direction of continuous folding is longer than a length of the plurality of sheet-like negative electrodes.

5. The secondary battery according to claim 1, wherein the belt-like separator is continuously folded back and forth along a short side of the plurality of sheet-like positive electrodes and the plurality of sheet-like negative electrodes.

6. The secondary battery according to claim 1, wherein
the belt-like separator has a first surface, and a second surface being a back side of the first surface and covered with ceramic, and
at a leading end and a terminal end of the belt-like separator, the first surface of the belt-like separator faces outward, and the second surface of the belt-like separator faces inward.

7. The secondary battery according to claim 1, wherein
the belt-like separator has a first surface, and a second surface being a back side of the first surface,
the second surface has less adhesive strength against a specified adhesive tape than the first surface, and
at a leading end and a terminal end of the belt-like separator, the first surface of the belt-like separator faces outward, and the second surface of the belt-like separator faces inward.

8. The secondary battery according to claim 2, further comprising:
wherein the adhesive tape is configured to secure a leading end or a terminal end of the belt-like separator,
wherein the leading end part or the terminal end part of the belt-like separator that covers an electrode in an outermost layer in the stacking direction is entirely covered with the adhesive tape.

9. The secondary battery according to claim 1, wherein
the belt-like separator does not cover a center part of an upper surface of an electrode located in an uppermost layer in the stacking direction or a center part of a lower surface of an electrode located in a lowermost layer in the stacking direction among the plurality of sheet-like positive electrodes and the plurality of sheet-like negative electrodes stacked together.
